(19) United States
(12) Patent Application Publication
(10) Pub. No.: US 2023/0205596 A1
(43) Pub. Date: Jun. 29, 2023

(54) AUTONOMOUS WORKLOAD MANAGEMENT IN AN ANALYTIC PLATFORM

(71) Applicant: Teradata US, Inc., San Diego, CA (US)

(72) Inventors: Naveen Thaliyl Sankaran, Hyderabad (IN); Lovlean Arora, Punjab (IN); Sourabh Maity, Howrah (IN); Stephen Andrew Brobst, Henderson, NV (US); Bhashyam Ramesh, Secunderabad (IN); Douglas P. Brown, Rancho Santa, CA (US)

(73) Assignee: Teradata US, Inc., San Diego, CA (US)

(21) Appl. No.: 18/056,573

(22) Filed: Nov. 17, 2022

Related U.S. Application Data
(63) Continuation-in-part of application No. 16/683,183, filed on Nov. 13, 2019, now Pat. No. 11,531,657.

(51) Int. Cl. G06F 9/50

(52) U.S. Cl. CPC G06F 9/505

(57) ABSTRACT

A data store system may include at least one storage device to store a plurality of data and at least one processor with access to the storage device. The at least one processor may receive a plurality of features associated with an environment. The at least one processor may further generate a state representation of the environment based on the plurality of features. The at least one processor may further generate a plurality of predicted future states of the environment based on the state representation. The at least one processor may further generate at least one action to be performed by the environment based on the plurality of predicted future states. The at least one processor may provide the at least one action to the environment to be performed. A method and computer-readable medium are also disclosed.

### CLAIM OF PRIORITY

This continuation-in-part application claims the benefit of priority under 35 U.S.C. § 120 of U.S. patent application Ser. No. 16/683,183 filed on Nov. 13, 2019, which is hereby incorporated by reference herein in its entirety.

### BACKGROUND

The past decade has seen the widespread adoption of machine learning (ML), and specifically neural networks (deep learning), in many different applications and systems. The database community also has started to explore how machine learning can be leveraged within data management systems. Recent research therefore investigates ML for classical database problems like parameter tuning, query optimization, and even indexing. Machine learning and artificial intelligence in general is not limited to the optimizer research. Machine learning can apply to all aspects of a database system, as well as other analytic platforms and data stores. These concepts may be applied to multiple areas in database management, such as managing service level goals (SLGs), database tuning, and query optimizations.

The ultimate goal is the implementation of a fully autonomous database system. A fully autonomous database should be able to predict the type of query—short running tactical or long complex running such as decision support system query. A fully autonomous database should further predict the parsing time, resource consumption, and running time of a query. Such abilities assist workload management functionalities to meet SLGs. A fully autonomous database should be able to predict future workloads based on past arrivals. For example, based on a past month's or a past week's workload and their respective arrivals, a fully autonomous database system should predict the workload for today by the hour or by a smaller granularity. Such features provide multiple benefits. For example, the decision to elastically scale up or down system configuration in a cloud or hybrid environment may be made. Moreover, it can deploy optimizations at a time that will have the least impact on performance. These forecast models help the database system tune and optimize for the expected workload.

Tuning is about determining actions along with the history of what happened to the system when such actions were invoked, which allows the system to team and apply appropriate actions in the future. Forecasting the load guides the application of these actions. Some examples of tuning actions include database physical design, data organization, such as partitioning, caching, location in the memory hierarchy and finally optimizations which affect runtime behavior like adding or removing nodes, and configuration parameters. For each tuning action, the database management system must estimate the potential effect on the database. These estimates not only include what resources the action will consume once it is deployed, but also the resources that the database management system will use to deploy it. The database system should be able to validate the effect of the actions on the workload and provide feedback to the prediction models for learning. Thus, a flexible, database management system architecture that can incrementally apply optimizations with no perceptible impact to the application during their deployment is a primary goal.

Query optimization is a very complex area and well amenable to machine learning. The intent of query optimization is to find a globally optimal plan for queries. Applying machine learning leads to superior plans since more of the space can be explored during training and a better model built that can predict better than applying algorithms. The process of optimization in a superior optimizer is cost-based. Cost-based optimization has multiple components—semantic query rewrite, cost formulas for cost determination of different sub-operations, selectivity estimation of selection and join predicates, selectivity estimation of complex functions, deriving statistics for intermediate relations, access path planning, binary join selection, join order selection, and interfacing with workload management, for example. Query optimization is fundamentally based on cardinality estimation. To be able to choose between different plan alternatives, the query optimizer must have reasonably good estimates for intermediate result sizes. It is well known, however, that the estimates produced by all widely-used database systems are routinely wrong by orders of magnitude—causing slow queries and unpredictable performance. Cardinality estimation has sometimes been called the “Achilles heel” of query optimization because it causes most performance related issues in the optimizer and workload management. An autonomous database system has many facets, such as automatic schema identification, automatic physical database design identification and automatic workload management, for example.

One aspect in ultimately achieving a fully autonomous database is autonomous management of workload service level goals (SLGs). In many database systems, a database administrator (DBA) or user with administrator privileges is required to manually configure various aspects of workload management, such as:

1. Classification rules: DBA or user establishes rules to categorize incoming queries or other requests into different workload groups. An example of this rule can be: “All the queries from application ‘Customer Registration’ should be categorized as Workload L.”

2. Priority of the defined workloads: DBA or user has to set the priority of each of the workload definitions. For example, a DBA or other user needs to place the defined workload definition (WD) into one of the following tiers (in descending order of priority), Tactical, SLG Tier 1 . . . SLG Tier 5, TimeShare Top, TimeShare High, TimeShare Medium, TimeShare Low.

3. Allocate relative share of resources (RelShare) for the workloads: A DBA or user needs to specify the relative percentage of resources allocated to each workload definition (WD). In one example, the resources to consider may be: a) CPU share percentages; b) I/O share percentages; and c) the reservation of atomic processing tasks for Tactical Workloads.

It would be beneficial to allow an analytic platform, such as that implementing a database system, to autonomously and dynamically control RelShare for the workloads.

### SUMMARY

According to one aspect of the disclosure, a data store system may include at least one storage device to store a plurality of data and at least one processor with access to the storage device. The at least one processor may receive a plurality of features associated with an environment. The at least one processor may further generate a state representation of the environment based on the plurality of features. The at least one processor may further generate a plurality of predicted future states of the environment based on the state representation. The at least one processor may further generate at least one action to be performed by the environment based on the plurality of predicted future states. The at least one processor may provide the at least one action to the environment to be performed.

According to another aspect of the disclosure, a method may include receiving, with a processor, a plurality of features associated with an environment. The method may further include generating, with the processor, a state representation of the environment based on the plurality of features. The method may further include generating, with the processor, a plurality of predicted future states based on the state representation. The method may further include generating, with the processor, at least one action to be performed by the environment based on the plurality of predicted future states. The method may further include providing, with the processor, the at least one action to the environment to be performed.

According to another aspect of the disclosure, a computer-readable medium may be encoded with a plurality of instructions executable by a processor. The plurality of instructions may include instructions to receive a plurality of features associated with an environment. The plurality of instructions may further include instructions to generate a state representation of the environment based on the plurality of features. The plurality of instructions may further include instructions to generate a plurality of predicted future states based on the state representation. The plurality of instructions may further include instructions to generate at least one action to be performed by the environment based on the plurality of predicted future states. The plurality of instructions may further include instructions to provide the at least one action to the environment to be performed.

### BRIEF DESCRIPTION OF THE DRAWINGS

The present disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a diagrammatic representation of an example database system.

FIG. 2 is an example of an architecture used for system prediction.

FIG. 3 is an example operational flow diagram of the architecture of FIG. 2.

FIG. 4 is an example operational flow diagram of a RelShare settings module.

FIG. 5 is an example operational flow diagram of a database system.

FIG. 6 is a block diagram of an example database system.

FIG. 7 is a block diagram of a portion of the example database system of FIG. 6.

FIG. 8 is a block diagram of another portion of the example database system of FIG. 6.

### DETAILED DESCRIPTION OF THE FIGURES

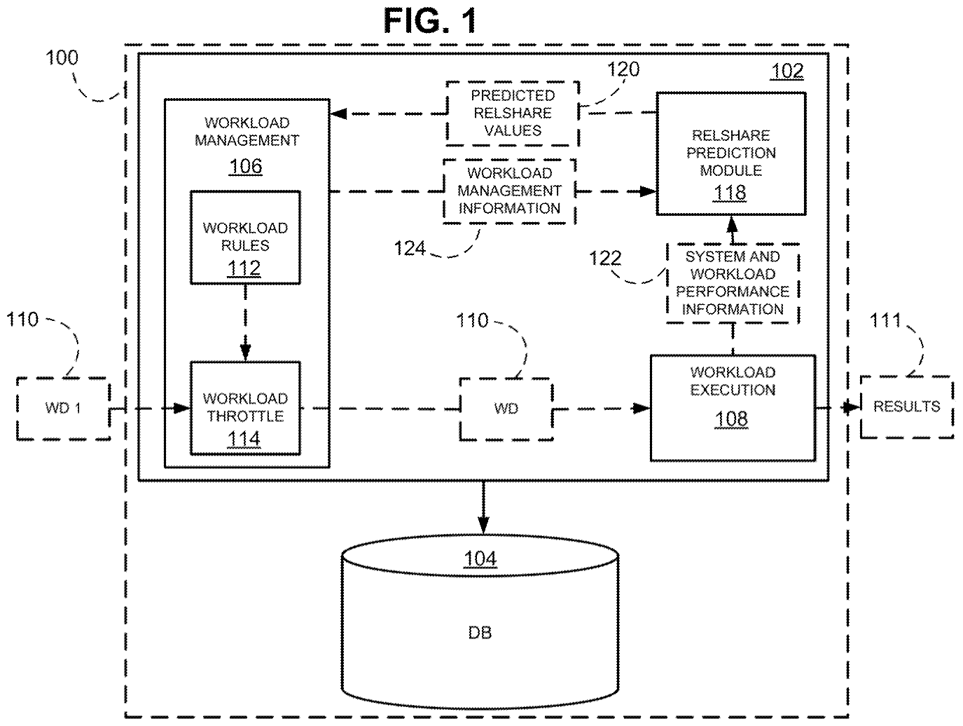

FIG. 1 is a diagrammatic representation of an example database system 100, which may be a relational database system. The database system 100 may include a relational database management system (RDBMS) 102 and a database (DB) 104. The database 104 may represent one or more storage and/or memory devices configured to persistently store database data in structured or unstructured form. The RDBMS 102 may include workload management 106 and workload execution 108. During operation, workload management 106 may be responsible for controlling the amount of workloads 110 that are processed by the workload execution 108.

Each workload (WD) 110 may include one or more requests, such as a query or other task, to be processed by the RDBMS 102. The workloads 110 may each be associated with tiered workload groups. In one example, each workload group may be defined by a particular priority and amount of dedicated resources allocated by the RDBMS 102. In one example, the workload groups may include tactical, SLG-tiered, and timeshare. The tactical workload group may be of the highest priority and any workload associated with the tactical group may be given priority to any resources needed that does not supersede another tactical workload received earlier in time. The SLG-tiered workload groups may be allocated a percentage of resources available outside of use by any tactical workloads. The timeshare workloads groups may share the resources not in use or reserved for the other tiers.

During operation, the workload management 106 may manage delivery of workloads 110 to the workload execution 108 at the SLG level based on the relative shared percentages of resources (RelShare) assigned to the workload groups associated with the workloads in order to meet the associated SLGs associated with workload group. The RelShare resources may include: a) CPU share percentages; b) I/O share percentages; and c) the reservation of atomic processing tasks for Tactical Workloads. On its own, the workload management 106 may manage workload delivery to the workload execution 108 based on SLGs and current system conditions to generate output results Il 1. The workload management 106 may implement workload rules 112, which define the workload groups and association with the received workloads. The workload management 106 may use the workload rules 112 to determine the RelShare percentages for SLG-tiered workloads. The workload management 106 may also implement a workload throttle 114, which determines the rate at which the workloads 110 are delivered to the workload execution 108.

The RDBMS 102 may employ a RelShare settings module (RSM) 18. The RSM 118 may provide RelShare values 120 to the workload management 106, which allows the workload management 106 to dynamically adjust RelShare settings based on RelShare values 120 determined by the RSM 118. In one example, the RSM 118 may determine RelShare values 120 using system and workload performance information 122 and workload information 124 as input. Based on these inputs, the RSM 118 may generate the RelShare values 120 to be used by the workload management 106 to dynamically adjust RelShare settings.

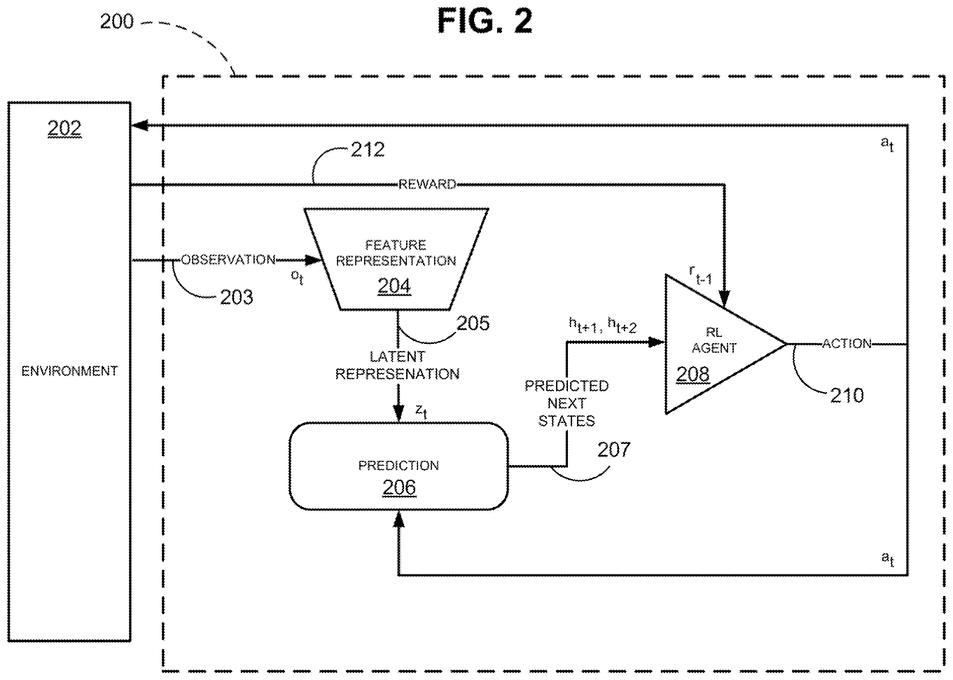

FIG. 2 is an example architecture 200 of the RSM 118. In one example, environment 202 may represent the actual environment facing the architecture 200. In the context of determining RelShare values, the environment 202 may be the RDBMS 102 represented by various performance metrics and/or parameters from the RDBMS 102, such as the system and workload performance information 122 and the workload information 124. The architecture 200 may include a features representation module 204. The feature representation module 204 module faces the environment 202 and is responsible for creating a latent representation (z) of the environment 202. For example, in the context of the RDBMS 102, the feature representation module 200 may receive the information from the RDBMS 102. In one example, at time instance t, the feature representation module 204 receives an input observation 203 (oₜ), which represents the observed environment 202 at time t. The feature representation 204 produces a latent representation (zₜ) 205 of the environment 202 at time t.

While time is a continuous variable in dynamically allocating resources in the RDBMS 102, time may be discretized by the feature representation 204 using a fixed time step where measuring features, planning, applying, monitoring, and iteratively learning/training a model occurs at each time step interval. Such discretization may be used in other systems implementing the architecture 200. In one example, a time step of one hour may be used, however, other time step increments may be used.

The latent representation 205 may be provided to a prediction module 206. In one example, the prediction module 206 may model two behaviors: 1. Trend of z (how the observed system (environment 2020) changes over time); and 2. How an action can influence the system state z. In one example, a prediction module 206 may output the predicted next states 207, represented as hₜ₊₁ and hₜ₊₂ in FIG. 2, based on the latent representation 205. In other examples, additional predicted future states may be used. The predicted next states 207 may be provided to a reinforcement learning (RL) agent module 208, which may be included in the architecture 200. The RL agent module 208 may produce an action (a) 212 to be carried out by a system, which in the context of the database system 100 is carried out by the RDBMS 102.

In one example, the prediction module 206 may be a machine learning model, which may be implemented as various types. The prediction module 206 may learn a function:

f:z_{1:t},aₜ→hₜ₊₁,hₜ₊₂ Eqn. 1

where z_{1:t} is the representation of all the previous states produced by the feature presentation module 204 and aₜ is the action chosen by the RL agent module 208 for time t at time t. In some examples the number of preceding states may be limited to a specified set less than the total set of all previous states. The prediction module 206 produces the predicted next state representations at times t+1 and t+2, which are designated as the predicted next states hₜ₊₁ and hₜ₊₂. In some scenarios, there can be difficulty in predicting a next state such as hₜ₊₁, where there is an insubstantial difference between h and hₜ₊₁ and the action appears to have no effect on the output. The difficulty may be enhanced when Δt is small. However, making the time step very large may increase the discretization and may disturb the time continuum. In one example, in order to overcome an issue, if present, Δh may be predicted rather than hₜ₊₁ so that hₜ₊₁=hₜ+Δh.

The reinforcement learning (RL) agent module 208 may receive the predicted next states 207 from the prediction module 206 as input to choose its actions 210. The “environment” for the RL agent module 208 is the output of the prediction module 206 and depends on how efficiently the prediction module 206 can model the predicted next states 207. Thus, the RL agent module 208 may learn the function:

g:hₜ₊ₜ,hₗ₊₁→aₜ₊₁∈A Eqn. 2

where A is the set of possible actions to be taken by the RL agent module 208.

The RL agent module 208 may take a current state as input, which would be hₜ₊₁ in the case for the architecture 200 as observed by the RL agent module 208, but the additional next state hₜ₊₂ is also being provided as an addition input. This allows the RL agent module 208 to look further ahead than hₜ₊₁ to assist in the generation of an efficient action 210. For example, a query may be given 30% CPU and can finish the query in an hour, but the query may also be given 10% CPU and finish the same query in three hours. With SLG-based requests, this is important since there is no reward for early completion. Using the 10% CPU scenario frees more CPU resources to be consumed by other queries but at the cost of the same query running longer, and thus, more concurrency and more system load for a longer period of time. Thus, if completing the query with the 10% CPU still meets the SLG, this would be the better choice since the additional resources would be available over the course of the request being executed.

Other variants for the RL agent module 208 may be implemented. For example, G, the expected return the reward R can get at the end of an episode through the prediction module 206 may be modeled. Thus, the input to the RL agent module may be expressed as:

f:z_{1:t},aₜ→hₜ₊₁,hₜ₊₂,G Eqn. 3

In this variant, the return R may be kept as simple as possible and be viewed through a perspective of the prediction module 206. This variant allows the RL agent module 206 to be aware of the long-term return G to “plan” its path efficiently. Thus, the following function may be learned by the RL agent module 206:

g:h₁₊ₜ,hₜ₊₂,G→aₜ₊₁∈A Eqn. 4

In the case of long episodes, there is a tradeoff of whether to act greedily or to plan for optimality over a period of time. Acting with the knowledge of the long-term return G is helpful in the case of long episodes but may not be as helpful for short episodes. The RL agent module 208 may learn to maximize long-term return G through actual “playouts”, but an explicit input may be more helpful. In this variant, there may be two predictive modules, one for both hₜ₊₁ and hₜ₊₂ and the long-term return G.

In a second variant, there is an option for R to learn without an action being generated by the RL agent module 208. If the prediction module 206 can predict the reward R, the RL agent module 208 is to receive after each time step, then it is possible for the RL agent module 208 to learn in this manner. Thus, the prediction module 206 may learn the function:

f:z_{1:t},aₜ→hₜ₊₁,hₜ₊₂,rₜ,G Eqn. 5

Where rₜ is the long-term reward R at timestep t. In this case, the prediction module 206 is self-sufficient to simulate the real environment for a large number of time steps with only the initial input to kickstart it without going back to the real environment afterwards. If the prediction module 206 has a certain level of accuracy, then the RL agent module 208 may be able to operate with input from the prediction module 206 and without actual “playouts” in the real environment. Thus, the RL agent module 208 may be trained from training data and fine tuned once exposed to the actual system implementing the architecture 200. In this variant, the RL agent module 208 may learn the function:

g:hₜ₊₁,hₜ₊₂,rₜ,G→aₜ₊₁∈A Eqn. 6

While adjusting the RDBMS 102 settings is non-episodic in nature due to the process of operating the RDBMS 102 being continuous in nature. In one example, the step size for the RL agent module 208 may be selected to be a discrete value with a constant step size (e.g. 2%). The state definition of the RL agent module 208 may be represented by the tuple (hₜ₊₁, hₜ₊₂, G). The actions (aₜ) 210 produced by the RL agent module 208 may be on a per workload basis. When modeling the action set for the RL agent module 208, one manner is to implement three actions per workload group: 1. “Up” (increasing RelShare by x %); 2. Down (decreasing RelShare by x %); and 3. Same (leave RelShare as is). The variable “x” may be a pre-defined constant which represents a step increment for increasing or decreasing RelShare, where x may be a percentage value ranging from 0 to 100. However, using this approach requires a tuple being specified as an action, such as (Up, 3). Thus, in one example, the RL agent module 210 output may be an integer n where:

n∈ [symbol] :−100/x≤n≤100/x Eqn. 7

where x may be the pre-defined step constant. Thus, an output of the RL agent module 208 of +3 signifies an increase of RelShare of a particular workload group by +3x %. Similarly, an output of −2 will signify a decrease of RelShare of a particular workload group by −2x %. Using this technique, the RL agent module 208 need only output with an action-space size of:

$$\vert A \vert = 2 * \frac{100}{x} \qquad Eqn . 8$$

In one example, the maximum size of the action space may be 200 (when x is minimum, i.e. 1). In other examples, the action space size may be increased or decreased according to how a system may perform overall, as well as a particular implementation.

The reward 212 awarded to the RL agent module 208 may depend upon how closely the requests meet their assigned SLG at each time step, which induces a penalty for early or late completion. The penalty for workload group Wi may be determined by:

Penalty_{w}_{ᵢ}=Σ|etᵢⱼ−SLG|² Eqn. 9

where et represents the elapsed time for a workload group. Eqn. 9 allows the penalty for all workload groups considered with equal priority. However, in instances where workload groups have relative priorities compared to one another, the penalties for workloads associated with the different workload groups may have weight penalties proportional with the respective priorities.

In another example for unlimited or high-limit resources, such as a cloud-based implementation, the penalty for a workload Wi may be determined by:

Penalty_{w}_{ᵢ}=Σ|gc−BUDGET|² Eqn. 10

where gc is the total cost of the workload group and BUDGET is the total budget (e.g., U.S. dollars) available for the workload group Wi. Such a penalty can improve the budget at the cost of delayed execution time. Such a penalty may be useful in cases where new resources are provisioned to avoid a missed SLG and the budget is not exceeded. The penalty may be considered as a function that can take multiple parameters (e.g., cost to execute the query and elapsed time) to determine if additional resources should be provided to the workload.

In one example, the reward may be defined by the dot product of two matrices:

Reward=−S^{T}(Penalty) Eqn. 11

where S is the significance matrix and Penalty is the penalty matrix. Both are of dimension N×1 with N being the total number of workload groups. Thus, the penalty matrix may be represented

$$Penalty = [ \begin{matrix}{Penalty}_{{W}_{1}} \\ ⋮ \\ {Penalty}_{{W}_{N}}\end{matrix} ]$$

The matrix S hold the weights for the penalties where a higher weight signifies a higher relative priority. The exact values of Sᵢ, the significance of workload group Wᵢ, using a heuristical approach. In one example, a Fibonacci series numbers may be used as the significant values. The term “reward” may be considered both a reward and penalty in the architecture 200 depending on the value. The reward may indicate the RelShare values 120 used by workload management 106 failed to meet one more SLGs, and thus, indicates a negative reward, or penalty.

In one example, the RSM 118 may be initially configured using training data. Training data may include benchmarks which are sets of requests and industry-accepted test beds. Each benchmark may be assumed to have some commonality that each benchmark qualifies as a workload group. Foreign benchmark requests may be included into each workload group as a form of noise to more closely model a more likely scenario to occur in a system. The SLG workload definitions will be defined such that x % of the queries fail to meet it when ran standalone (no concurrency).

When determining the actual execution of the workload groups, there are several factors to be observed. With regard to query execution, the prediction module 206 captures the trend and effect of RelShare on the trend. To create the trend, queries may be executed as a mix of different clusters during each monitoring window. For example, for a specified hour a basket of queries may be scheduled to run in which 60% are taken for a first cluster, 30% taken from a second cluster, and 10% taken from a third cluster. By creating differently-sized baskets of queries for different time steps, a different degree of concurrency is created. Thus, the trend of each metric (CPU consumption, I/O consumption, and elapsed time) can be controlled over a period of time. To allow the prediction module to learn the effect of different RelShares, the differently-sized baskets may be executed with a different RelShare.

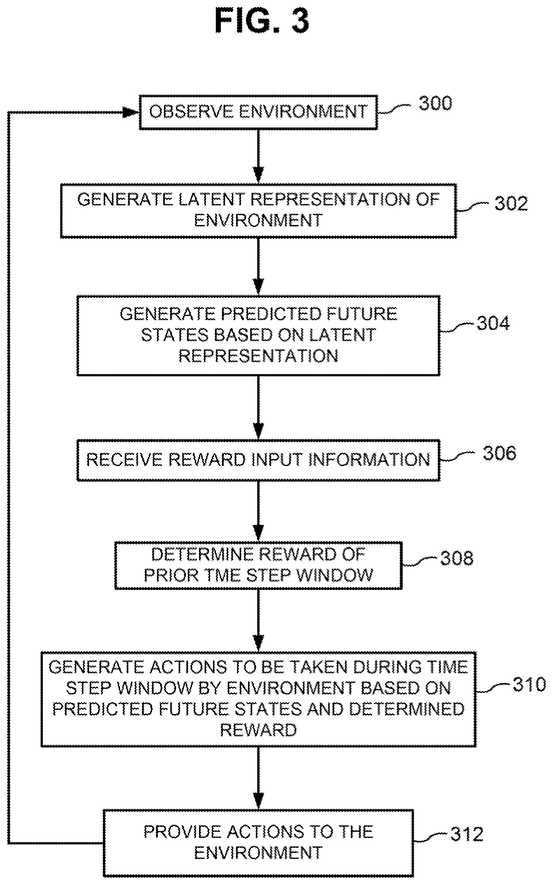

FIG. 3 is an operational flow diagram of example operation of the architecture 200. In one example, the architecture 200 may observe an environment 200 (300), which in one example may be performed by the feature representation module 204. The architecture 200 may generate a latent representation 203 the environment 202 (302). In one example, the feature representation module 204 may generate the latent representation 203. The architecture 200 may generate one or more predicted future states 205 of the environment 200 (304), which in one example may be performed by the prediction module 206.

The architecture 200 may receive reward input information 212 (306), which may represent results from prior actions by the environment 200 (e.g. such as those at time t−1). The reward may be determined by the architecture 200 using the reward input information 212 (308). In one example, this may be performed by the RL agent module 208. The architecture may generate actions 210 to be taken by the environment 200 based on the reward and the predicted next states 207 (310). In one example, this may be performed by the RL agent module 208. The architecture 200 may provide the generated actions to the environment 200 (312), which in one example may be performed by the RL agent module 208. The architecture 200 may continue to observe the environment 200 in order ultimately generate future actions 210, if any, that are to be performed.

In other examples, the RSM 118 may implement the long-term return G as previously described. In one example, a boundary condition for operation of the RSM 118 may be established and the long-term return G determined over one boundary increment. For example, the long-term return G may be determined over a one day period. This may be used with the variants discussed in adjusting the action space of the RL agent module 208.

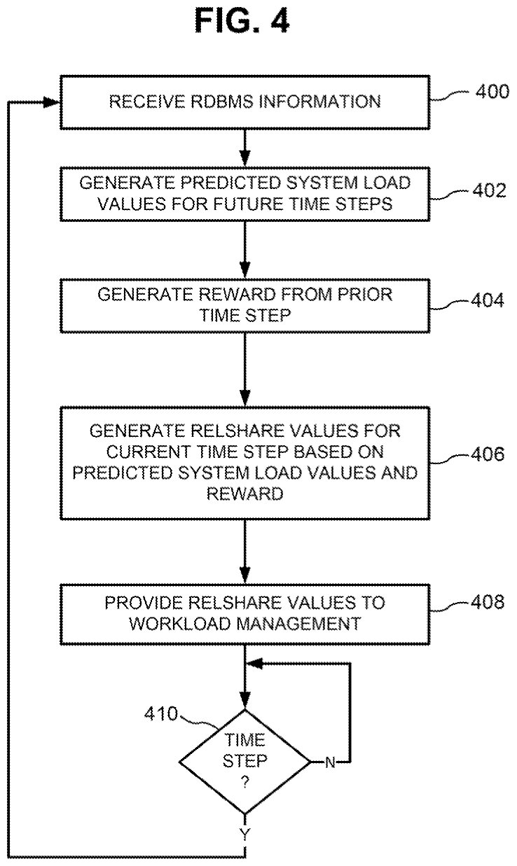

FIG. 4 is an operational flow diagram of the RSM 118. In one example, the RSM 118 may receive information from the RDBMS 102 (400). In one example, this may include system and workload performance information 122, workload management information 124. Within these results, the information to determine the reward may be included. The RSM 118 may generate the predicted future system load values for future time steps (402), which may be based on a latent representation 205 generated by the RSM 112 representing the observed RDBMS 102. The RSM 118 may provide determine the reward from the prior time step window using the reward information 212, (404). In one example, the reward may be determined through a comparison of the workload execution results for the SLG-workloads with the SLGs.

Using the predicted future system load values and the determined reward, the RSM 112 may generate RelShare values for workload management 106 to use towards the workload groups for the current time step window (406). The RSM 118 may provide the RelShare values to workload management 106 (408). If a time step has not expired (410), the RSM 118 may wait until it receives additional information from the RDBMS 102 for the next time step. If the time step has expired (410), the RSM 118 may receive the RDBMS 102 information (400), which may include the results from execution of the workloads using the predicted RelShare values 120.

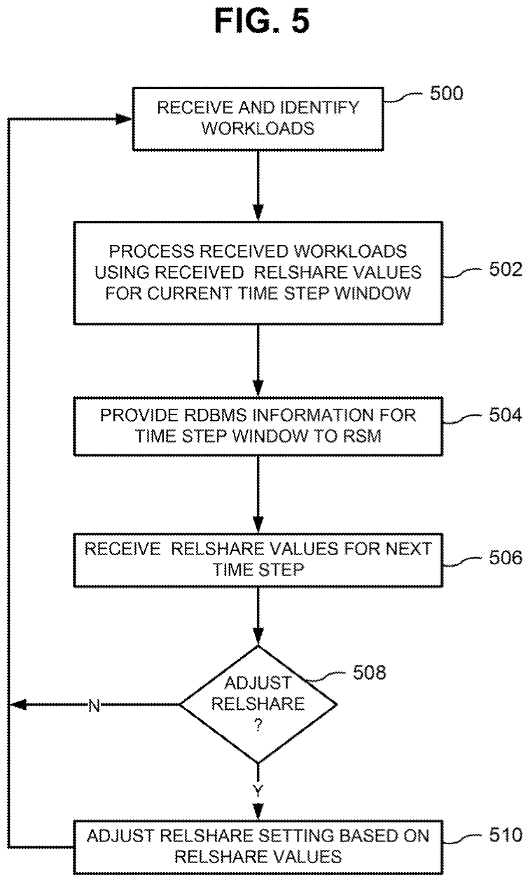

FIG. 5 is an operational flow diagram of the RDBMS 102 during example operation with the RSM 118. In one example, the RDBMS 102 may receive and identify the workloads 110 (500). The RDBMS 102 may determine the workload groups associated with the received workloads. Based on the RSM 112 may, initial RelShare settings may have been provided to the workload management 106, which may be used to process the received workloads during a time step (502). In one example, the RSM 118 may be trained using training data with the initial RelShare values 120 being based off the results of the training data. However, once in operation the RSM 118 will operate from actual information from the RDBMS 102. The RDBMS 102 may provide information to the RSM 112 for the time step (504). Upon completion of the current time step window, the RDBMS 102 may receive the RelShare values 120 from the RSM 112 for the next time step window (506) and determine if any adjustments need to be made (508). If adjustments to the current settings need to be made, workload management 106 may adjust accordingly (510). Once adjustments, if any, have been made, the RDBMS 102 may continue to receive and identify received workloads (500).

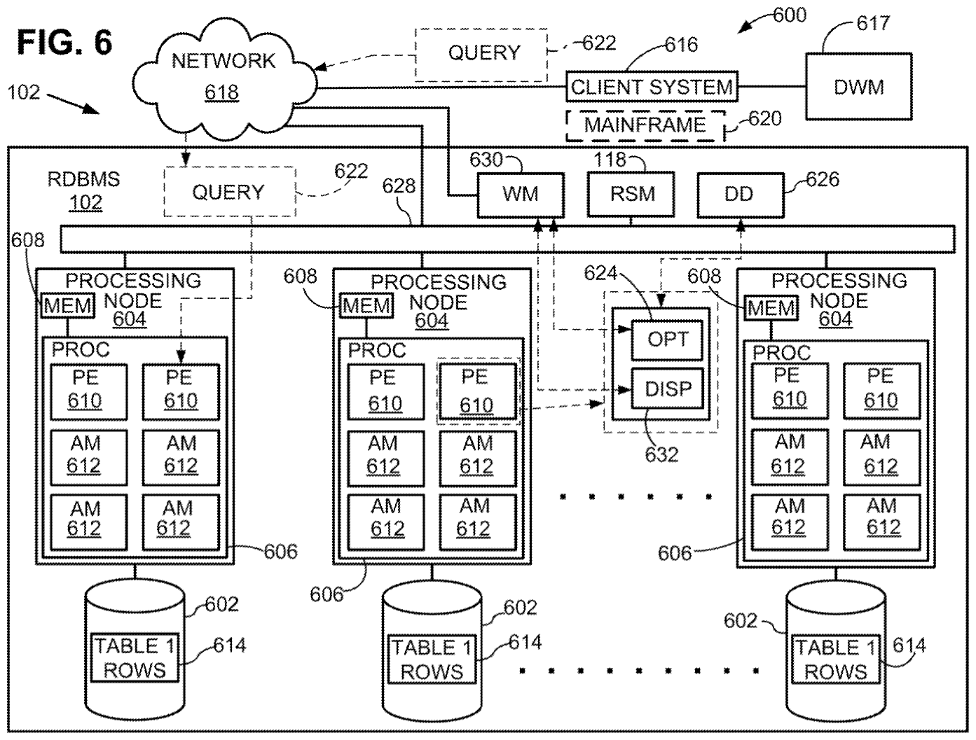

FIG. 6 is a diagrammatic representation of example architecture for an analytic platform 600, which may implement the database system 100, such as a Teradata Vantage. In one example, the database system 600 includes the relational database management system (RDBMS) 102 that implements a parallel-processing environment to carry out database management. The RDBMS 102 may be a combination of software (e.g., computer program routines, subroutines, applications, etc.) and hardware (e.g., processors, memory, etc.). In the example of FIG. 1, the RDBMS 102 may be a massive parallel processing (MPP) system having an array of processing units and distributed memory. In alternative examples, the RDBMS 102 may implement a single processing unit, such as in a symmetric multiprocessing (SMP) system configuration. The RDBMS 102 may include one or more processing units used to manage the storage, retrieval, and manipulation of data in data storage facilities (DSFs) 602, which may be those that store the database 104. The array of processing units may include an array of processing nodes 604 that manage the storage, retrieval, and manipulation of data included in a database.

In one example, each processing node 604 may include one or more physical processors 606 and memory 608. The memory 608 may include one or more memories and may be computer-readable storage media or memories, such as a cache, buffer, RAM, removable media, hard drive, flash drive or other computer-readable storage media. Computer-readable storage media may include various types of volatile and nonvolatile storage media. Various processing techniques may be implemented by the processors 606 such as multiprocessing, multitasking, parallel processing and the like, for example.

The processing nodes 604 may include one or more other processing unit arrays such as parsing engine (PE) modules 610 and access modules (AM) 612. The access modules 612 may be access modules processors (AMPs), such as those implemented in the Teradata Active Data Warehousing System®. The parsing engine modules 610 and the access modules 612 may each be virtual processors (vprocs) and/or physical processors. In the case of virtual processors, the parsing engine modules 610 and access modules 612 may be executed by one or more physical processors, such as those that may be included in the processing nodes 604. For example, in FIG. 6, each parsing engine module 108 and access module 612 is associated with a respective processing node 604 and may each be executed as one or more virtual processors by physical processors 608 included in the respective processing node 604.

In FIG. 6, each processing node 604 is shown as including multiple parsing engine modules 610 and access modules 612, such that there are more parsing engine modules 610 and access modules 612 than processing nodes 604. In one example, during operation, the one or more physical processors 606 included in the processing nodes 604 may execute the parsing engine modules 610 and access modules 612 by switching between the executions of the various modules at a rapid rate allowing the vprocs to substantially operate in “parallel.”

The RDBMS 102 stores data in one or more tables in the DSFs 602. In one example, rows 614 of a table, “Table I,” are distributed across the DSFs 602 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 602 and associated access modules 612 by a hash bucket map. The characteristics of the columns chosen for the primary index determine how evenly the rows are distributed.

Rows of each stored table may be stored across multiple DSFs 602. Each parsing engine module 610 may organize the storage of data and the distribution of table rows. The parsing engine modules 610 may also coordinate the retrieval of data from the DSFs 602 in response to queries received, such as those received from a client computer system 616 connected to the RDBMS 102 through connection with a network 618. The network 618 may be wired, wireless, or some combination thereof. The network 618 may be a virtual private network, cloud-based, web-based, directly-connected, or some other suitable network configuration. In one example, the client computer system 616 may run a dynamic workload manager (DWM) client 617. Alternatively, the database system 100 may include a mainframe 620 used to interact with the RDBMS 102.

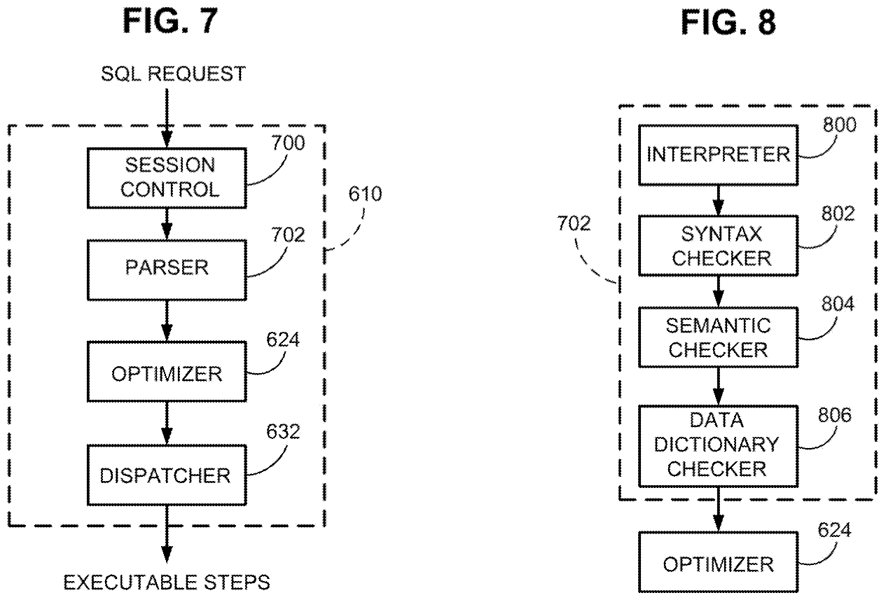

Each parsing engine module 610, upon receiving an incoming database query, such as the query 622, may apply an optimizer module 624 to assess the best plan for execution of the query. An example of an optimizer module 624 is shown in FIG. 1 with regard to parsing engine module 610. Additional description of the parsing engine modules 610 is provided with regard to FIGS. 2 and 3. Selecting the optimal query-execution plan may include, among other things, identifying which of the processing nodes 604 are involved in executing the query and which database tables are involved in the query, as well as choosing which data-manipulation techniques will serve best in satisfying the conditions of the query. To this end, for each parsing engine module 610, a parser module 702 (see FIG. 7), and/or optimizer module 624 may access a data dictionary module 626, shown in FIG. 1 specifically for parsing engine module 610 for purposes of illustration.

The data dictionary module 626 may specify the organization, contents, and conventions of one or more databases, such as the names and descriptions of various tables maintained by the RDBMS 102 as well as fields of each database, for example. Further, the data dictionary module 626 may specify the type, length, and/or other various characteristics of the stored tables. The RDBMS 102 typically receives queries in a standard format, such as the structured query language (SQL) put forth by the American National Standards Institute (ANSI). However, other formats, such as contextual query language (CQL), data mining extensions (DMX), and multidimensional expressions (MDX), for example, may be implemented in the database system 102 separately or in conjunction with SQL. The data dictionary may be stored in the DSFs 602 or some other storage device and selectively accessed.

An interconnection 628 allows communication to occur within and between each processing node 604. For example, implementation of the interconnection 628 provides media within and between each processing node 604 allowing communication among the various processing units. Such communication among the processing units may include communication between parsing engine modules 610 associated with the same or different processing nodes 604, as well as communication between the parsing engine modules 610 and the access modules 612 associated with the same or different processing nodes 604. Through the interconnection 628, the access modules 612 may also communicate with one another within the same associated processing node 604 or other processing nodes 604.

The interconnection 628 may be hardware, software, or some combination thereof. In instances of at least a partial-hardware implementation the interconnection 628, the hardware may exist separately from any hardware (e.g., processors, memory, physical wires, etc.) included in the processing nodes 604 or may use hardware common to the processing nodes 604. In instances of at least a partial-software implementation of the interconnection 628, the software may be stored and executed on one or more of the memories 608 and processors 606 of the processing nodes 604 or may be stored and executed on separate memories and processors that are in communication with the processing nodes 604. In one example, interconnection 128 may include multi-channel media such that if one channel ceases to properly function, another channel may be used. Additionally, or alternatively, more than one channel may also allow distributed communication to reduce the possibility of an undesired level of communication congestion among processing nodes 604.

The RDBMS 102 may include a workload management (WM) module 630, which may represent at least part of workload management 106. The WM module 630 may be implemented as a “closed-loop” system management (CLSM) architecture capable of satisfying a set of workload-specific goals. In other words, the RDBMS 102 is a goal-oriented workload management system capable of supporting complex workloads and capable of self-adjusting to various types of workloads. The WM module 630 may communicate with each optimizer module 624, as shown in FIG. 8, and is adapted to convey a confidence threshold parameter and associated parameters to the optimizer module 624 in communication. Further, the WM module 630 may communicate with a dispatcher module 632 of each parsing engine module 610 (as shown in detail FIG. 6 for parsing engine module 610 to receive query execution plan costs therefrom, and to facilitate query exception monitoring and automated modifications of confidence threshold parameters in accordance with disclosed embodiments. The DWM client 617 may communicate with the WM module 630 via the network 618. In one example, the WM module 630 may be part of each parsing engine module 610, and in some examples, part of the dispatcher module 632.

The RDBMS 102 described herein accepts performance goals for each workload as inputs, and dynamically adjusts its own performance, such as by allocating RDBMS 102 resources and throttling back incoming work. Performance parameters may be referred to as priority scheduler parameters. In one example, the priority scheduler may optionally implement multiple virtual partitions to allocate certain portions of resources (such as CPU, disk, and memory) by geographical entities or business units if they require strict separations and limits. Each virtual partition may implement multiple priority levels with appropriate resources. Each workload is assigned to a specific priority level possibly with its allocation of resources within its priority level. Thus, the amount of resources that a workload receives depends on its assigned priority level within a virtual partition. For example, some requests may be associated with tasks of a more critical nature as compared to other requests. To ensure these types of requests receive a proper amount of resources, the associated workload of these critical-task requests may be assigned to the highest priority level (e.g., in a virtual partition that provides more resources compared to other virtual partitions if there are multiple virtual partitions). Requests of a less-critical nature may be associated with workloads assigned to lower priority levels. Given performance objectives for each workload and the fact that the workloads may interfere with each other's performance through competition for shared resources, the RDBMS 102 may find a performance setting that achieves one workload's goal but makes it difficult to achieve another workload's goal. Workloads may contain one or more of queries and/or utilities received from a particular source. In one example, the workloads may be prioritized based on a number of configurable parameters such as user names, profiles, query characteristics, query types, databases, tables, applications, etc. The performance goals for each workload will vary widely as well and may or may not be related to their resource demands. For example, two workloads that execute the same application could have differing performance goals simply because they were submitted from different departments in an organization. Conversely, even though two workloads have similar performance objectives, they may have very different resource demands.

The operation of the WM 630 may include four major phases: 1) assigning a set of incoming request characteristics to workloads which have been defined with appropriate priority classes, and assigning goals (called Service Level Goals or SLGs); 2) monitoring the execution of the workloads against their goals; 3) regulating (adjusting and managing) the workload flow and priorities to achieve the SLGs; and 4) correlating the results of the workload and taking action to improve performance. The performance improvement can be accomplished in several ways: 1) through performance tuning recommendations such as the creation or change in index definitions or other supplements to table data, or to recollect statistics, or other performance tuning actions; 2) through capacity planning recommendations, for example increasing system power; 3) through utilization of results to enable optimizer self-learning; and 4) through recommending adjustments to SLGs of one workload to better complement the SLGs of another workload that it might be impacting. All recommendations can either be enacted automatically, or through manual input.

In one example system, each parsing engine module 610 includes three primary components: a session control module 700, a parser module 702, and a dispatcher module 632 as shown in FIG. 7. The session control module 700 provides the logon and logoff functions. It accepts a request for authorization to access the database, verifies it, and then either allows or disallows the access. Once the session control module 700 allows a session to begin, a SQL request may be received such as through submission by a user and the SQL request is routed to the parser module 702.

As illustrated in FIG. 8, the parser module 702 may include an interpreter module 800 that interprets the SQL request. The parser module 702 may also include a syntax checker module 802 that checks the request for correct SQL syntax, as well as a semantic checker module 804 that evaluates the request semantically. The parser module 702 may additionally include a data dictionary checker 806 to ensure that all of the objects specified in the SQL request exist and that the user has the authority to perform the request. The parsing engine module 610 implements the optimizer module 624 to select the least expensive plan to perform the request, and the dispatcher 632 coordinates the runtime execution of executable steps of the query execution plan of the optimizer module 624 with the access modules 612.

In the context of the using the RSM 118 in the RDBMS 102 of FIG. 6, the RSM 118 may be executed on one or more of the processing nodes 604 or may operate on independent processors that communicate internally with the RDBMS 102. The RSM 118 may operate independently in that it may act as on observer for each WM module 630. The RSM 118 may communicate through the interconnection 128 and/or may communicate in other manners to receive the information from the RDBMS 102 used to provide RelShare values 120. In one example, the RSM 118 may receive various features from the RDBMS 102, which in one example may include:
1. CPU numbers: CPU percentage share allowed, CPU percentage consumed, CPU percentage wait;
2. I/O bound: For each I/O request, how many bytes are read and for each CPU cycle, the average I/O performed;
3. amp worker task (AWT) numbers: In one example, each AWT may represent the atomic level of processing for each access module 612. The AWT numbers may include AWT consumed in total, maximum AWT consumption at a given time, AWTs exhausted, i.e. AWT shortage. These numbers may be calculated for six categories of work: new, spawn, utilities, tactical, abort, miscellaneous;
4. Arrival Rate Meter: Number of requests received and completed, number of sessions, number of AWT released;
5. Average Lock Wait Time (Lock wait time/Lock wait count): Amount of average time queries spend waiting for lock. Lock wait time includes lock wait for database objects, file segment cache (FSG), and segments;
6. Average Other Wait Times (Other wait time/other wait count): Amount of average time queries spend waiting for other things like wait time for monitor, message, etc.; and
7. Input queue wait time: Waiting time that work requests waited on an input queue before being serviced.
   In some examples, additional features corresponding to cloud-based usage costs may be used in cloud-based implementations.

These example features may come from the WM 630 and database query logs that log request execution information. Other features may be considered in other implementations beyond those specifically listed and in some implementations fewer features than those listed may be used.

In one example, the features may be normalized to percentages whenever possible, such as for CPU numbers. Those may be converted for a particular workload group into percentages with respect to the CPU of the system. For features such as wait time, the average wait time/monitoring window may be averaged to convert it into a percentage, e.g., percentage of time out of monitored time queries spent waiting. For features like AWT consumed, where percentage is not directly applicable, binning may be used in which each bin indicates what percentage of available AWTs consumed.

As described herein, each module, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, that comprises instructions executable with one or more processors to implement one or more of the features of the module. When any one of the modules includes a portion of the memory hardware that comprises instructions executable with the processor, the module may or may not include a processor. In some examples, each module may just be the portion of the memory hardware or other physical memory that comprises instructions executable with one or more processors to implement the features of the corresponding module without the module including any other hardware. Because each module includes at least some hardware even when the included hardware comprises software, each module may be interchangeably referred to as a hardware module, such as the parsing engine hardware module or the access hardware module, for example.

The examples herein have been provided with the context of a relational database system. However, all examples are applicable to various types of data stores, such as file systems or other data stores suitable for organization and processing of data, such as analytic platforms. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system comprising:
at least one storage device to store a plurality of data;
at least one processor with access to the storage device, the at least on processor configured to:
receive a plurality of features associated with an environment;
generate a state representation of the environment based on the plurality of features;
generate a plurality of predicted future states of the environment based on the state representation;
generate at least one action to be performed by the environment based on the plurality of predicted future states; and
provide the at least one action to the environment to be performed.

2. The system of claim 1, wherein the processor is further configured to generate at least one metric indicative of prior performance of the environment.

3. The system of claim 1, wherein the environment comprises a data store system.

4. The system of claim 3, wherein the processor is further configured to wherein the at least one processor is further configured to:
receive a plurality of features indicative of an operational state of the data store system;
generate a plurality of predicted future states of the data store system based on the state representation;
generate at least one metric indicative of prior performance of the data store system;
generate at least one action to be performed by the data store system based on the plurality of future states and the at least one metric; and
provide at least one action to the data store system.

5. The system of claim 4, wherein the plurality of predicted future states are indicative of predicted future system load of the data store system.

6. The system of claim 4, wherein the at least one action is at least one setting for a relative share of resources for at least one workload to be processed by the data store system.

7. The system of claim 4, wherein the at least one metric comprises a plurality of metrics each indicative of a service level goal being met for a workload group.

8. A method comprising:
receiving, with a processor, a plurality of features associated with an environment;
generating, with the processor, a state representation of the environment based on the plurality of features;
generating, with the processor, a plurality of predicted future states based on the state representation;
generating, with the processor, at least one action to be performed by the environment based on the plurality of predicted future states; and
providing, with the processor, the at least one action to the environment to be performed.

9. The method of claim 8 further comprising generating, with the processor, at least one metric indicative of prior performance of the environment.

10. The method of claim 8, wherein the environment comprises a data store system.

11. The method of claim 10, wherein the processor is further configured to wherein:
receiving, with a processor, a plurality of features associated with an environment comprises receiving, with the processor, a plurality of features indicative of an operational state of the data store system comprises;
generating, with a processor, a state representation of the environment based on the plurality of features comprises generating a plurality of predicted future states based on the state representation;
generating, with the processor, at least one action to be performed by the environment based on the plurality of predicted future states and the at least one metric comprise generating, with the processor, at least one action to be performed by the data store system based on the plurality of future states and the at least one metric comprises; and
providing at least one action to the data store system comprises providing, with the processor, the at least one action to the environment to be performed.

12. The method of claim 11, wherein the plurality of predicted future states are indicative of predicted future system load of the data store system.

13. The method of claim 11, wherein the at least one action is at least one setting for a relative share of resources for at least one workload to be processed by the data store system.

14. The method of claim 11, wherein the at least one metric comprises a plurality of metrics each indicative of a service level goal being met for a workload group.

15. A computer-readable medium encoded with a plurality of instructions executable by a processor, the plurality of instructions comprising:
instructions to receive a plurality of features associated with an environment;
instructions to generate a state representation of the environment based on the plurality of features;
instructions to generate a plurality of predicted future states based on the state representation;
instructions to generate at least one action to be performed by the environment based on the plurality of predicted future states; and
instructions to provide the at least one action to the environment to be performed.

16. The computer-readable medium of claim 15, wherein the plurality of instructions further comprises generating at least one metric indicative of prior performance of the environment.

17. The computer-readable medium of claim 15, wherein the environment comprises a data store system.

18. The computer-readable medium of claim 15, wherein:
instructions to receive a plurality of features associated with an environment comprise instructions to receive a plurality of features indicative of an operational state of the data store system comprises;
instructions to generate a state representation of the environment based on the plurality of features comprise instructions to receive a plurality of predicted future states based on the state representation;
instructions to generate at least one action to be performed by the environment based on the plurality of predicted future states and the at least one metric comprise instructions to generate at least one action to be performed by the data store system based on the plurality of future states and the at least one metric comprises; and
instructions to provide at least one action to the data store system comprise instructions to provide the at least one action to the environment to be performed.

18. The computer-readable medium of claim 17, wherein the plurality of predicted future states are indicative of predicted future system load of the data store system.

19. The computer-readable medium of claim 17, wherein the at least one action is at least one setting for a relative share of resources for at least one workload to be processed by the data store system.

20. The computer-readable medium of claim 17, wherein the at least one metric comprises a plurality of metrics each indicative of a service level goal being met for a workload group.
